(19) United States
(12) Patent Application Publication
(10) Pub. No.: US 2026/0001991 A1
(43) Pub. Date: Jan. 1, 2026

(54) PROCESSING PLASTIC SOLVOLYSIS MIXTURES

(71) Applicant: RAMPF ADVANCED POLYMERS GMBH & CO. KG, Grafenberg (DE)

(72) Inventor: Michael KUGLER, Pirmasens (DE)

(73) Assignee: RAMPF ADVANCED POLYMERS GMBH & CO. KG, Grafenberg (DE)

(21) Appl. No.: 18/881,675

(22) PCT Filed: Jul. 6, 2023
(86) PCT No.: PCT/EP2023/068667

§ 371 Date: Jan. 6, 2025

(30) Foreign Application Priority Data
Jul. 7, 2022 (EP) 22183494.8

(51) Int. Cl. C08G 71/04; B01D 69/02; B01D 71/68

(52) U.S. Cl. CPC C08G 71/04; B01D 69/02; B01D 71/68; B01D 2325/34

(57) ABSTRACT

The present invention relates to a method for separating a plastic solvolysis mixture comprising plastic degradation product, solvent and catalyst by means of membrane filtration. The resulting fractions can be recycled and reused, for example, for the solvolysis of plastics or as raw materials for the production of plastics.

The present invention relates to a method for separating a plastic solvolysis mixture comprising plastic degradation product, solvent and catalyst by means of membrane filtration. The obtained fractions can be recycled and reused, for example, for the solvolysis of plastics or as raw materials for producing plastics.

Plastics are ubiquitous materials and are intensively used, among others, as packaging materials, fibers, insulation, foams and construction materials, e.g. in vehicle construction. Plastics are usually based on petrochemical starting products. Especially in times of increasing resource scarcity, but also in view of the problem of increasing environmental pollution, recycling methods are becoming increasingly important.

Recycling of plastics can involve the mechanical, thermal or chemical degradation of plastics. In chemical degradation, the plastics are broken down into their monomers by chemical reaction, which can be reused as starting materials in a variety of chemical methods. However, the economic significance of chemical recycling is limited by the process effort and the costs associated therewith. In particular, complex purification processes are required to separate the plastic degradation products generated from the chemicals used, such as solvents and catalysts.

The degradation of plastics and plastic waste by means of solvolysis (such as glycolysis, alcoholysis, acidolysis, aminolysis, hydrolysis) with the addition of low-molecular cleavage reagents such as glycols, alcohols, acids, amines or water is well known. The cleavage reagents are generally used in excess in order to achieve the most quantitative conversion possible. The resulting plastic solvolysis mixtures are mixtures of different low-molecular plastic degradation products and further contain cleavage reagents.

Plastic solvolysis mixtures are sometimes used as a mixture, including excess cleavage reagents, as a raw material. For example, polyurethane rigid (PUR) foam waste is solvolyzed using glycols. The resulting mixture of ether polyols, urethanes and free glycol is added as a raw material in the production of rigid PUR foam on a percentage basis. However, the use of these plastic solvolysis mixtures is severely limited, as the excess cleavage reagents interfere with the subsequent application. By-products of plastic degradation and catalysts, which generally has to be added during solvolysis to ensure sufficient plastic degradation, also are disadvantageous.

Therefore, there is the need to improve the recycling of plastics and, in particular, to provide methods in which the plastic degradation products have lower residual cleavage reagent contents and lower quantities of catalyst and by-products.

In order to reduce the residual cleavage reagent content, the cleavage reagent was therefore partially added as an underfeed. Although as result, the content of cleavage reagent in the plastic solvolysis mixtures is slightly reduced, the resulting mixtures have a higher viscosity or are highly molecular and are still present as a mixture with residual contents of catalyst and degradation by-products.

The plastic solvolysis mixture can also be subjected to distillation in order to reduce the cleavage reagent content. However, after distillation, the plastic solvolysis mixtures are still present as unfavorable mixtures of plastic degradation products and may have increased catalyst contents. Further, distillative separation methods are disadvantageous in that only vaporizable reagents can be separated and, in addition, side reactions occur due to the thermal load, the products thereof being disruptive during further processing.

This approach also has the disadvantage that plastic solvolysis mixtures cannot be sufficiently separated or processed to higher purities in order to be used in significant quantities as a raw material in the chemical or plastics industry. As a result, methods such as the hydrolysis of plastics have never been able to establish themselves in economic terms.

Also, it has not been possible so far to reuse the catalyst that is sometimes used in larger quantities in solvolysis. In order to achieve at least partial removal of the catalyst from the plastic solvolysis mixture in the methods described above, the catalyst is often neutralized (e.g. hydrolyzed), separated by distillation or filtration, and disposed of.

Despite the high relevance of methods for the degradation of plastics, there is currently a shortage of methods that enable the separation of plastic solvolysis mixtures into sufficiently pure plastic degradation products and the recovery of solvolysis reagents such as catalyst and/or cleavage reagent (solvent) under economic conditions.

The object of the present invention is therefore to provide a method that enables the separation of plastic solvolysis mixtures by simple means. In particular, a reduction in process costs, for example by reusing solvolysis reagents such as catalyst and/or solvent, is of interest. Furthermore, the method according to the present invention is directed to an improved separation of plastic solvolysis mixtures, whereby improved further processing of the plastic degradation products obtained is made possible and the associated added value is increased.

Surprisingly, it was found that a significantly improved separation of plastic solvolysis mixtures is possible using membrane filtration. The resulting plastic degradation product fractions have a higher purity than conventionally obtained plastic degradation product fractions and can therefore be used to a greater extent as a raw material, for example for the production of plastics. Furthermore, the solvent and catalyst can be separated with less effort and can also be fed back into the plastics degradation process. It is particularly advantageous that the catalysts used in the solvolysis, such as sodium methylates, potassium acetates and titanates, can be separated without prior decomposition. This means that they can be recycled and, for example, can be fed back into the plastic degradation process.

Thus, the method according to the present invention allows a simple, effective separation of cleavage reagents as well as the catalyst in a still active form. In addition to increasing the economic efficiency of the method, this makes it possible to use excess cleavage reagents and catalyst in plastic solvolysis and thus to allow the solvolysis reaction to proceed more quantitatively and significantly faster, even at lower temperatures.

A first aspect of the present invention therefore relates to a method for separating a plastic solvolysis mixture comprising the following steps:
a) providing a liquid plastic solvolysis mixture comprising plastic degradation product, solvent and catalyst,
b) carrying out a membrane filtration of the plastic solvolysis mixture provided in step a) at a temperature of 5-300° C., preferably 50-200° C., and a pressure of 2-150 bar, preferably 5-100 bar, to obtain a filtration residue A and a filtrate B,
   wherein the weight ratio catalyst:plastic degradation product in the filtrate B obtained in step b) is higher than in the plastic solvolysis mixture provided in step a).

The plastic solvolysis mixture provided in step a) comprises plastic degradation product, solvent and catalyst. Preferably, the liquid plastic solvolysis mixture is present in the form of a solution. In one embodiment, the plastic solvolysis mixture provided in step a) is subjected to a solid/liquid filtration prior to step a).

The term “plastic solvolysis mixture” as used herein means that the provided mixture is obtained by solvolysis of plastic. Solvolysis reactions of plastics are known to the person skilled in the art and comprise, for example, a glycolysis, alcoholysis, acidolysis, aminolysis or hydrolysis of plastic. The solvolysis reaction takes place under the addition of solvolysis cleavage reagents such as glycols (in the case of glycolysis), alcohols (in the case of alcoholysis), acids (in the case of acidolysis), amines (in the case of aminolysis) or water (in the case of hydrolysis). The plastic may be selected from the group consisting of polyurethane, polyester, polyether ester, polyamide, polycarbonate, polyisocyanurate or a mixture thereof. In a preferred embodiment, the plastic may be selected from the group consisting of polyurethane and/or polyester, in particular polyurethane.

The plastic degradation product obtained by solvolysis may be selected from polyamines, polyols, carbamates, polycarboxylic acids, polycarboxylic acid esters, hydroxycarboxylic acids, hydroxycarboxylic acid esters or mixtures thereof. Preferably, the plastic degradation product is selected from polyamines, polyols, carbamates, polycarboxylic acids and/or polycarboxylic acid esters. In a preferred embodiment, the plastic degradation product comprises at least one polyol and at least one polyamine.

The plastic degradation product can have a weight-average molecular weight of 30-20,000 g/mol, preferably 50-10,000 g/mol, in particular 100-5,000 g/mol.

The content of plastic degradation product in the plastic solvolysis mixture provided can, for example, be up to 70 wt. %, preferably 5-60 wt. %, such as 5-20 wt. %, in particular in the case of a glycolysis mixture, or 40-60 wt. %, in particular in the case of an alcoholysis mixture, based on the total weight of the mixture.

In one embodiment, the plastic degradation product comprises at least one polyol, in particular when the solvolyzed plastic is a polyurethane and/or polyester. The term “polyol” refers to compounds having at least 2, i.e. 2, 3, 4 or more, hydroxyl groups. A polyol within the meaning of the present invention is preferably a polyether polyol, in particular aliphatic, e.g. polyethylene glycol or polypropylene glycol, or aromatic polyether polyol, polyester polyol, in particular aliphatic or aromatic polyester polyol, diethylene glycol, dipropylene glycol, C1-6-alkylene glycol, in particular hexanediol, butanediol, ethylene glycol and neopentyl glycol, C1-8-alkylene polyol, in particular trimethylolpropane and glycerol, or a mixture thereof.

In one embodiment, the plastic degradation product comprises at least one polycarboxylic acid, in particular when the solvolyzed plastic is a polyester. A polycarboxylic acid within the meaning of the present invention may comprise, for example, an aromatic polycarboxylic acid, preferably phthalic acid or terephthalic acid, or an aliphatic polycarboxylic acid, preferably C1-12 alkylenedicarboxylic acid, more preferably C1-6 alkylenedicarboxylic acid, for example adipic acid, succinic acid or glutaric acid, esters or mixtures thereof.

In one embodiment, the plastic degradation product comprises at least one hydroxy-functionalized carboxylic acid, in particular when the solvolyzed plastic is a polyester. A hydroxy-functionalized carboxylic acid within the meaning of the present invention may comprise, for example, a hydroxyhexamethylenecarboxylic acid, a hydroxypopanoic acid such as lactic acid, a hydroxy fatty acid or hydroxybutyric acid.

In one embodiment, the plastic degradation product comprises at least one polyamine, in particular when the solvolyzed plastic is a polyamide and/or a polyurethane. The term “polyamine” refers to compounds having at least 2, that is 2, 3, 4 or more, preferably 2 or 3, amino groups. A polyamine within the meaning of the present invention can be, for example, an aromatic diamine, preferably 2,4-diaminotoluene, 2,6-diaminotoluene, 4,4′-diaminodiphenylmethane, 2,2′-diaminodiphenylmethane, 2,4′-diaminodiphenylmethane or aniline, an aliphatic polyamine, for example a linear aliphatic polyamine such as, for example, hexamethylenediamine, an aliphatic polyamine such as, for example, hexamethylenediamine or aniline, an aliphatic polyamine such as, for example, a linear aliphatic polyamine such as, for example, hexamethylenediamine and triethylenetetramine, or a cyclic aliphatic polyamine such as isophorone diamine.

The plastic solvolysis mixture provided in step a) comprises at least one solvent. The solvent, which can serve in particular as a solvolysis cleavage reagent in a solvolysis of plastic, is preferably selected from alcohols, glycols, amines or mixtures thereof. Suitable solvolysis cleavage reagents are known to the skilled person.

In one embodiment, in particular in aminolysis, the solvent comprises at least one amine selected from methylamine, ethylamine, ethanolamine or mixtures thereof.

In a preferred embodiment, in particular in alcoholysis or glycolysis, the solvent is selected from monoalcohols, dialcohols, glycols or mixtures thereof. Monoalcohols are alcohols having a hydroxy group. Suitable monoalcohols are in particular methanol, ethanol, propanol or mixtures thereof. Dialcohols (i.e. diols) are alcohols having two hydroxyl groups.

A suitable dialcohol is in particular butanediol. Suitable glycols are in particular ethylene glycol, diethylene glycol, propylene glycol, dipropylene glycol or mixtures thereof, preferably diethylene glycol.

In one embodiment, the solvent has a molecular weight of 30-500 g/mol, preferably 30-250 g/mol.

The solvent content in the plastic solvolysis mixture provided may, for example, be more than 40 wt. %, preferably 50-95 wt. %, for example 70-90 wt. %, in particular in the case of an alcoholysis mixture, or 40-60 wt. %, in particular in the case of a glycolysis mixture, based on the total weight of the mixture.

The plastic solvolysis mixture provided in step a) comprises at least one catalyst. Suitable solvolysis catalysts are known to the person skilled in the art. In one embodiment, the catalyst is an alcoholate, preferably a methanolate, ethanolate or butanolate or a mixture thereof. Preferably, the catalyst is an alkali metal methanolate and particularly preferably potassium methanolate or sodium methanolate. An alcoholate catalyst such as potassium methanolate or sodium methanolate is particularly present when the solvent (i.e. the solvolysis cleavage reagent) is an alcohol such as methanol, ethanol, propanol or a mixture thereof.

In one embodiment, the catalyst is a metal catalyst such as titanium tetrabutanolate, tetrabutyl titanate, zinc-, magnesium or cobalt acetate, or a mixture thereof. In particular, a metal catalyst such as tetrabutyl titanate is present when the solvent (i.e. the solvolysis cleavage reagent) is a glycol, such as diethylene glycol.

The content of catalyst in the plastic solvolysis mixture provided can, for example, be more than 0 and up to 10 wt. %, preferably 0.1-5 wt. %, in particular 0.5-3 wt. %, based on the total weight of the mixture.

The molecular weight of the catalyst can be 30-500 g/mol, preferably 50-350 g/mol.

In step b), membrane filtration of the plastic solvolysis mixture provided in step a) is carried out at a temperature of 5-300° C., preferably 50-200° C., and a pressure of 2-150 bar, preferably 5-100 bar, in order to obtain a filtration residue A and a filtrate B.

The membrane used in step b) for membrane filtration can, for example, be a ceramic membrane or a polymer membrane. Suitable ceramic membranes comprise, for example, aluminum oxide, titanium dioxide, silicon dioxide, zirconium dioxide, silicon carbide or mixtures thereof. Suitable polymer membranes include, for example, polysulfones, polyether sulfones, cellulose, cellulose esters (such as cellulose acetate or cellulose nitrate), regenerated cellulose, silicones, polyamides, polyamidimide, polycarbonates, polyacrylonitrile, polyethylene, polypropylene, polytetrafluoroethylene, polyvinylidene fluoride, polyvinyl chloride, polypiperazinamide, polyetherimide or mixtures thereof.

Preferably, the membrane in step b) has a cut-off (MWCO) of 10-6000 Da, preferably 100-6000 Da. The flux rate of the membrane filtration in step b) can be up to 300 g/m² membrane area/h, for example 10-100 g/m² membrane area/h.

The membrane filtration in step b) is carried out at a temperature of 5-300° C., preferably 50-200° C. For example, the temperature may be 50-100° C. or 100-200° C. In one embodiment, the membrane in step b) is a ceramic membrane and the temperature in this step is 5-300° C., preferably 50-300° C., more preferably 100-200° C. In one embodiment, the membrane in step b) is a polymer membrane and the temperature in this step is 5-300° C., preferably 5-100° C., more preferably 50-100° C.

The membrane filtration in step b) is carried out at a pressure of 2-150 bar, preferably 5-100 bar. For example, the pressure can be 5-40 bar. In one embodiment, the membrane in step b) is a ceramic membrane and the pressure in this step is 2-60 bar, preferably 5-40 bar. In one embodiment, the membrane in step b) is a polymer membrane and the pressure in this step is 2-150 bar, preferably 5-100 bar.

In one embodiment, the membrane filtration in step b) is a diafiltration. In a diafiltration, further solvent is added to the fraction retained by the membrane and is again subjected to membrane filtration. The added solvent is as defined herein and preferably corresponds to the solvent present in the plastic solvolysis mixture. The solvent can be added in a volume corresponding to 0.5-10 times the volume of the retained fraction. By diafiltration in step b), for example, the catalyst content in the filtrate B can be further increased.

By the membrane filtration in step b) a filtration residue A and a filtrate B is obtained. The weight ratio of catalyst:plastic degradation product in the filtrate B obtained in step b) is higher than in the plastic solvolysis mixture provided in step a). In particular, the filtrate B obtained in step b) has a relative proportion of catalyst with respect to the content of catalyst in the plastic solvolysis mixture provided in step a) (corresponding to 100%) calculated by the formula

(amount of catalyst in B[g]/amount of catalyst in the plastic solvolysis mixture [g])×100%

of 80% or more, preferably 85% or more.

The filtrate B obtained in step b) may have a content of catalyst and optionally solvent of 90 wt. % or more, preferably 95 wt. % or more, in particular 98 wt. % or more based on the total weight of the filtrate B.

The filtrate B is preferably a mixture of solvent and catalyst. Other compounds such as plastic degradation products are preferably present in filtrate B only as impurities, i.e. in an amount of not more than 10 wt. %, preferably not more than 5 wt. %, in particular not more than 1.0 wt. %, based on the total weight of the filtrate B. In particular, the filtrate B is suitable for reuse as a solvolysis reagent comprising catalyst and solvent (solvolysis cleavage reagent) in a plastic solvolysis reaction.

It was surprisingly found that the method according to the present invention enables a simple and effective separation of solvent (cleavage reagent) and catalyst. Since the separated catalyst remains active and is not deactivated (e.g. hydrolyzed) for separation, as is common in the prior art, the reagents can be recycled and, in particular, fed to a new plastic solvolysis reaction. In addition to increasing the cost-effectiveness of the method, this makes it possible to use cleavage reagents and catalyst in excess in the plastic solvolysis, thus allowing the solvolysis reaction to take place in a more quantitative and significantly faster manner, even at lower temperatures.

The solvolysis reagents can be separated by the method according to the present invention with reduced effort compared to conventional purification methods such as distillation. It is particularly advantageous that the catalysts used in solvolysis, such as alkali metal alcoholates, (alkali) metal acetates and titanates, can be separated without their prior decomposition and in high concentrations. They can therefore be recycled and fed back into a plastic solvolysis process, for example. This makes it possible, for example, to establish the plastic solvolysis process as a continuous method with downstream purification and catalyst/solvent recovery.

The filtration residue A obtained in step b) has a weight ratio of plastic degradation product: catalyst which is preferably higher than that in the plastic solvolysis mixture provided in step a). In particular, the filtration residue A obtained in step b) has a relative proportion of plastic degradation product with respect to the content of plastic degradation product in the plastic solvolysis mixture provided in step a) (corresponds to 100%) calculated by the formula

$$( amount of plastic degradation product in A [ g ] / amount of plastic degradation product in the plastic solvolysis mixture [ g ] ) \times 100 \%$$

of 150% or more, preferably 200% or more and in particular 240% or more.

The filtration residue A preferably comprises plastic degradation product, for example a mixture of at least one polyol and at least one polyamine. Other compounds such as catalyst and/or solvent are preferably present in the filtration residue A only as impurities, i.e. in an amount of not more than 1.0 wt. %, preferably not more than 0.50 wt. %, based on the total weight of the filtration residue A. In a preferred embodiment, the filtration residue A is substantially free of catalyst. Substantially free of catalyst means that the content of catalyst in the filtration residue A obtained in step b) is 0.10 wt. % or less, preferably 0.010 wt. % or less, particularly preferably 0.0050 wt. % or less, based on the total weight of the filtration residue A.

Further, the filtration residue A can be subjected to a distillation. Suitable distillation conditions are, in particular, temperatures of 20-300° C. and pressures of 0.0001-1 bar. This can be used in particular to separate or purify the filtration residue A.

A separation/purification of the filtration residue A can also be carried out by membrane filtration. The method according to the present invention may further comprise the step:
c) carrying out a membrane filtration of the filtration residue A obtained in step b) at a temperature of 5-300° C., preferably 50-200° C. and a pressure of 2-150 bar, preferably 5-100 bar in order to obtain a filtration residue C and a filtrate D.

The membrane used in step c) for membrane filtration may be, for example, a ceramic membrane or a polymer membrane as defined herein. Preferably, the membrane in step c) has a cut-off (MWCO) of 10-6000 Da, preferably 100-3000 Da or 3000-6000 bar. The flux rate of the membrane filtration in step c) can be up to 300 g/m² membrane area/h, for example 10-100 g/m² membrane area/h.

The membrane filtration in step c) is carried out at a temperature of 5-300° C., preferably 50-200° C. For example, the temperature may be 50-100° C. or 100-200° C. In one embodiment, the membrane in step c) is a ceramic membrane and the temperature in this step is 5-300° C., preferably 50-300° C., more preferably 100-200° C. In one embodiment, the membrane in step c) is a polymeric membrane and the temperature in this step is 5-300° C., preferably 5-100° C., more preferably 50-100° C.

The membrane filtration in step c) is carried out at a pressure of 2-150 bar, preferably 5-100 bar. For example, the pressure can be 5-40 bar. In one embodiment, the membrane in step c) is a ceramic membrane and the pressure in this step is 2-60 bar and preferably 5-40 bar. In one embodiment, the membrane in step c) is a polymer membrane and the pressure in this step is 2-150 bar, preferably 5-100 bar.

In one embodiment, the membrane filtration in step c) is a diafiltration. In a diafiltration, further solvent is added to the fraction retained by the membrane and again subjected to membrane filtration. The solvent added is as defined herein and preferably corresponds to the solvent present in the plastic solvolysis mixture. The solvent may be added in an amount as described herein. By diafiltration in step c), for example, the content of a plastic degradation product in the filtrate D can be further increased.

By the membrane filtration in step c) a filtration residue C and a filtrate D is obtained. In one embodiment, the filtration residue C comprises at least one polyol plastic degradation product and the filtrate D comprises at least one polyamine plastic degradation product as defined herein. In another embodiment, the filtration residue C comprises at least one polyamine plastic degradation product and the filtrate D comprises at least one polyol plastic degradation product as defined herein. The polyol fraction C or D may comprise a polyol content of at least 80 wt. %, in particular at least 85 wt. %, preferably at least 90 wt. %, based on the total weight of the filtration residue C or the filtrate D. The polyamine fraction D or C may comprise a polyamine content of at least 80 wt. %, in particular at least 85 wt. %, preferably at least 90 wt. %, based on the total weight of the filtrate D or the filtration residue C.

Furthermore, the filtration residue C and/or the filtrate D may comprise solvent.

In one embodiment, the filtration residue C is subjected to a distillation. Suitable distillation conditions are in particular temperatures of 20-300° C. and pressures of 0.0001-1 bar. This can be used in particular to separate or purify the filtration residue C, for example to separate solvent. Separation/purification of the filtration residue C can also be carried out by membrane filtration.

In one embodiment, the filtrate D is subjected to a distillation. Suitable distillation conditions are, in particular, temperatures of 20-300° C. and pressures of 0.0001-1 bar. This can be used in particular to separate or purify the filtrate D, for example, to separate solvent. Separation/purification of the filtrate D can also be carried out by membrane filtration.

In one embodiment, the method according to the present invention further comprises at least one additional membrane filtration step:
dn) carrying out a membrane filtration of the filtration residue or the filtrate obtained in the previous step at a temperature of 5-300° C., preferably 50-200° C. and a pressure of 2-150 bar, preferably 5-100 bar in order to obtain a filtration residue En and a filtrate Fn.

The method may comprise one or more membrane filtration steps dn). For example, the method according to the present invention comprises one membrane filtration step d1), two membrane filtration steps d1) and d2), or three membrane filtration steps d1), d2) and d3). In membrane filtration step d1), the filtration residue C and/or the filtrate D can be subjected to membrane filtration. In step d2), the filtration residue E1 from step d1) and/or the filtrate F1 from step d1) can be subjected to membrane filtration, etc.

In a preferred embodiment, the method according to the present invention comprises
c) carrying out a membrane filtration of the filtration residue A obtained in step b) at a temperature of 5-300° C., preferably 50-200° C., and a pressure of 2-150 bar, preferably 5-100 bar in order to obtain a filtration residue C and a filtrate D;
   and an additional membrane filtration step
d1) carrying out a membrane filtration of the filtration residue C obtained in the previous step at a temperature of 5-300° C., preferably 50-200° C. and a pressure of 2-150 bar, preferably 5-100 bar in order to obtain a filtration residue E1 and a filtrate F1
or
   carrying out a membrane filtration of the filtrate D obtained in the previous step at a temperature of 5-300° C., preferably 50-200° C. and a pressure of 2-150 bar, preferably 5-100 bar to obtain a filtration residue E1 and a filtrate F1.

The membrane used in step dn) for membrane filtration may be independently selected from a ceramic membrane and a polymer membrane as defined herein. Preferably, the membrane in at least one step dn) has a cut-off (MWCO) of 10-6000 Da, preferably 100-3000 Da or 3000-6000 Da. The flux rate of the membrane filtration in at least one step dn) can be up to 300 g/m² membrane area/h, for example 10-100 g/m² membrane area/h.

In one embodiment, the cut-off (MWCO) of the membrane in step c) is preferably 100-3000 Da and the cut-off (MWCO) of the membrane in at least one step dn), in particular in step d1), is 3000-6000 Da.

In one embodiment, the cut-off (MWCO) of the membrane in step c) is preferably 3000-6000 Da and the cut-off (MWCO) of the membrane in at least one step dn), in particular in step d1), is 100-3000 Da.

The membrane filtration in at least one step dn), in particular d1), is carried out at a temperature of 5-300° C., preferably 50-200° C. For example, the temperature may be 50-100° C. or 100-200° C. In one embodiment, the membrane in at least one step dn), in particular d1), is a ceramic membrane and the temperature in this step is 5-300° C., preferably 50-300° C., more preferably 100-200° C. In one embodiment, the membrane in at least one step dn), in particular d1), is a polymeric membrane and the temperature in this step is 5-300° C., preferably 5-100° C., in particular 50-100° C.

The membrane filtration in at least one step dn), in particular d1), is carried out at a pressure of 2-150 bar, preferably 5-100 bar. For example, the pressure may be 5-40 bar. In one embodiment, the membrane in at least one step dn), in particular d1), is a ceramic membrane and the pressure in this step is 2-60 bar, preferably 5-40 bar. In one embodiment, the membrane in at least one step dn), in particular d1), is a polymer membrane and the pressure in this step is 2-150 bar, preferably 5-100 bar.

In one embodiment, the membrane filtration is a diafiltration in at least one step dn), preferably in all steps dn). In a diafiltration, the fraction retained by the membrane is mixed with further solvent and subjected to membrane filtration again. The solvent added is as defined herein and preferably corresponds to the solvent present in the plastic solvolysis mixture. The solvent can be added in an amount as described herein. By diafiltration in a step dn), for example, the content of a plastic degradation product in the filtrate Fn can be further increased.

In one embodiment, both the membrane filtration in step c) and the membrane filtration in at least one step dn), in particular in step d1), is a diafiltration. Such a method may comprise that the fraction retained by the membrane in step c) and the fraction retained by the membrane in at least one step dn), in particular d1), are mixed and further solvent is added. The mixture thus obtained is again subjected to membrane filtration in steps c) and dn).

A filtration residue En and a filtrate Fn are obtained by a membrane filtration in step dn). In one embodiment, a filtration residue En, such as a filtration residue E1, comprises at least one polyol plastic degradation product and a filtrate Fn, such as a filtrate F1, comprises at least one polyamine plastic degradation product as defined herein. In another embodiment, a filtration residue En, such as a filtration residue E1, comprises at least one polyamine plastic degradation product and a filtrate Fn, such as a filtrate F1, comprises at least one polyol plastic degradation product as defined herein. A polyol fraction En or Fn may comprise a polyol content of at least 80 wt. %, in particular at least 85 wt. %, preferably at least 90 wt. %, based on the total weight of the filtration residue En or the filtrate Fn. A polyamine fraction Fn or En may comprise a polyamine content of at least 80 wt. %, in particular at least 85 wt. %, preferably at least 90 wt. %, based on the total weight of the filtrate Fn or the filtration residue En.

A polyol fraction En or Fn from step dn) differs in particular from a polyol fraction C or D from step b) by its molecular weight. In one embodiment, a polyol fraction C or D from step b) has a higher molecular weight than a polyol fraction En or Fn from step dn). In another embodiment, a polyol fraction C or D from step b) has a lower molecular weight than a polyol fraction En or Fn from step dn).

A filtration residue En and/or a filtrate Fn may further comprise solvent.

In one embodiment, a filtration residue En is subjected to a distillation. Suitable distillation conditions are, in particular, temperatures of 20-300° C. and pressures of 0.0001-1 bar. This can be particularly used to separate or purify the filtration residue En, for example to separate solvent. Separation/purification of the filtration residue En can also be carried out by membrane filtration in a subsequent step dn+1).

In one embodiment, a filtrate Fn is subjected to a distillation. Suitable distillation conditions are, in particular, temperatures of 20-300° C. and pressures of 0.0001-1 bar. This can be used in particular to separate or purify the filtrate Fn, for example to separate solvent. Separation/purification of the filtrate Fn can also be carried out by membrane filtration in a subsequent step dn+1).

Another aspect of the present invention relates to a method for separating a plastic solvolysis mixture comprising the following steps:
a) providing a liquid plastic solvolysis mixture comprising plastic degradation product, solvent and optionally catalyst
b) carrying out a membrane filtration of the plastic solvolysis mixture provided in step a) at a temperature of 5-300° C., preferably 50-200° C. and a pressure of 2-150 bar, preferably 5-100 bar to obtain a filtration residue A and a filtrate B,
c) optionally carrying out a membrane filtration of the filtration residue A obtained in step b) at a temperature of 5-300° C., preferably 50-200° C. and a pressure of 2-150 bar, preferably 5-100 bar in order to obtain a filtration residue C and a filtrate D
   and optionally at least one additional membrane filtration step
dn) carrying out a membrane filtration of the filtration residue or filtrate obtained in the previous step at a temperature of 5-300° C., preferably 50-200° C. and a pressure of 2-150 bar, preferably 5-100 bar in order to obtain a filtration residue En and a filtrate Fn,
   wherein the weight ratio of solvent: plastic degradation product in the filtrate B obtained in step b) is higher than in the plastic solvolysis mixture provided in step a).

Suitable embodiments of this method are as defined herein for the first aspect of the present invention.

It was surprisingly found that the method according to the present invention enables a significantly improved separation of plastic solvolysis mixtures. The resulting plastic degradation product fractions have a higher purity than conventionally obtained plastic degradation product fractions and can therefore be used to a greater extent as a raw material, for example for the production of plastics. Furthermore, solvents and optionally catalyst can be separated with less effort and also fed back into the plastic degradation process.

Thus, the method according to the present invention allows a simple, effective separation of cleavage reagents and optionally of the catalyst which remains active. In addition to increasing the economic efficiency of the process, this makes it possible to use a surplus of cleavage reagents and optionally catalyst in the plastic solvolysis and thus to allow the solvolysis reaction to proceed more quantitatively and significantly faster, even at lower temperatures.

A further aspect of the present invention relates to a plastic degradation product obtainable by a method according to the present invention. Preferably, the plastic degradation product is liquid at room temperature (20° C.) and is present in particular in the form of a homogeneous, liquid mixture or in pure form. The viscosity of the plastic degradation product is in particular 10-100,000 mPa s, measured at 20° C.

The plastic degradation product may be selected from polyamines, polyols, carbamates, polycarboxylic acids, acid polycarboxylic esters, hydroxycarboxylic acids, hydroxycarboxylic acid esters or mixtures thereof. Preferably, the plastic degradation product is selected from polyamines, polyols, carbamates, polycarboxylic acids and/or polycarboxylic acid esters. In a particularly preferred embodiment, the plastic degradation product comprises at least one polyol, at least one polyamine or a mixture thereof.

In contrast to plastic degradation products obtainable by conventional methods, the plastic degradation products obtainable by the method according to the present invention have a higher purity and can thus be used to a greater extent as a raw material, for example for the production of plastics. In particular, the plastic degradation products obtained by means of the method according to the present invention have a lower content of solvolysis catalyst and/or solvolysis cleavage reagent.

Preferably, the content of catalyst in the plastic degradation product according to the present invention is not more than 5 wt. % and in particular not more than 1.0 wt. %, preferably not more than 0.50 wt. %, particularly preferably not more than 0.010 wt. %.

Preferably, the content of solvent in the plastic degradation product according to the present invention is not more than 5 wt. % and in particular not more than 1.0 wt. %.

A further aspect of the present invention relates to a use of the plastic degradation product according to the invention for the production of plastics, in particular polyurethanes.

A further aspect of the present invention relates to a use of the filtrate obtained in step b) for a solvolysis of plastics.

Furthermore, the present invention will be explained by the following examples.

### EXAMPLE 1—GLYCOLYSIS

An exemplary mixture of ether polyol (Lupranol 2095, 49.45%), low-molecular dipropylene glycol (49.45%) and 0.1% tetrabutyl titanate, as can typically occur during glycolysis of flexible polyurethane foams, was filtered at 57 bar and 60° C. using a PURA membrane (PuraMemFlux). The filtrate contained 91.2% of dipropylene glycol and tetrabutyl titanate and could be directly reused as a cleavage reagent for the glycolysis of plastics. The filtration residue had a polyol content of >90% and was used as a starting material in polyurethane production without further separation/purification steps.

The titanium content (catalyst) in the initial mixture and in the filtrate was detected using ICP-OES measurements. Titanium contents (catalyst) of 244.2 mg/kg titanium in the initial mixture and 215.4 mg/kg titanium in the filtrate were measured. This shows that the catalyst was able to effectively pass through the membrane. Thus, the method according to the present invention enables high amounts of the catalyst to be recovered in the filtrate and the filtrate with Ti concentrations >88% to be reused directly for the next cleavage reaction.

### EXAMPLE 2—METHANOLYSIS

Flexible polyurethane foam waste (16%) was depolymerized with an excess of methanol (74%) and 10% sodium methylate at 160° C. and 16 bar. Due to the strongly basic nature of the catalyst, the mixture had a pH of 10.54 (25° C.). The resulting mixture of methanol, ether polyol, toluylenediamine and sodium methanolate was processed by membrane filtration. In a first step, the mixture was subjected to membrane filtration on a NADIR NP030 P membrane based on polyethersulfone at a pressure of 62 bar and a temperature of 25° C. The filtrate was a mixture of ether polyol, toluylene diamine and sodium methanolate. The filtrate obtained was a mixture of methanol (98.96%) and toluylenediamine (TDA) (1.04%). The filter residue contained 38.55% ether polyol.

By adding fresh methanol to the filter residue and subsequent membrane filtration, the polyol-containing filter residue was further purified by diafiltration and reduced in TDA content (multi-stage membrane filtration).

After removal of the remaining methanol (by distillation), the ether polyol enriched in the resulting filter residue could be used directly as a polyol for plastics production, e.g. in the manufacture of flexible polyurethane foam.

The filtrate of methanol and toluene diamine was purified by further membrane filtration (PURA membrane). The resulting filtrate had a methanol concentration of 99.95% and a TDA concentration of 0.05% at a determined pH value of 10.14. Due to the high basicity (basic catalyst), the filtrate could be reused directly as a cleavage reagent without the need for a new catalyst additive.

The methanol was removed from the filter residue (TDA fraction) by distillative separation. The resulting TDA was used as a base monomer for polymer syntheses or, after phosgenation, for isocyanate production.

The following items are the subject of the invention:
1. A method for separating a plastic solvolysis mixture comprising the following steps:
   a) providing a liquid plastic solvolysis mixture comprising plastic degradation product, solvent and catalyst
   b) carrying out a membrane filtration of the plastic solvolysis mixture provided in step a) at a temperature of 5-300° C., preferably 50-200° C. and a pressure of 2-150 bar, preferably 5-100 bar in order to obtain a filtration residue A and a filtrate B,
wherein the weight ratio catalyst:plastic degradation product in the filtrate B obtained in step b) is higher than in the plastic solvolysis mixture provided in step a).
2. The method according to item 1, further comprising the step of
   c) carrying out a membrane filtration of the filtration residue A obtained in step b) at a temperature of 5-300° C., preferably 50-200° C. and a pressure of 2-150 bar, preferably 5-100 bar in order to obtain a filtration residue C and a filtrate D.
3. The method according to item 2, further comprising at least one additional membrane filtration step
   dn) carrying out a membrane filtration of the filtration residue or filtrate obtained in the previous step at a temperature of 5-300° C., preferably 50-200° C. and a pressure of 2-150 bar, preferably 5-100 bar in order to obtain a filtration residue En and a filtrate Fn.
4. The method according to item 2, comprising a additional membrane filtration step
   d1) carrying out a membrane filtration of the filtration residue C or filtrate D obtained in the previous step at a temperature of 5-300° C., preferably 50-200° C. and a pressure of 2-150 bar, preferably 5-100 bar in order to obtain a filtration residue E1 and a filtrate F1.
5. The method according to any one of the preceding items, wherein the plastic solvolysis mixture is in the form of a solution.
6. The method according to any one of the preceding items, wherein the membrane filtration in step b), c) and/or dn) is a diafiltration.
7. The method according to any one of the preceding items, wherein the flow rate step b), c) and/or dn) is up to 300 g/m² membrane area/h, preferably 10-100 g/m² membrane area/h membrane area.
8. The method according to any one of the preceding items, wherein the membrane in step b), c) and dn) is a ceramic membrane or a polymer membrane.
9. The method according to any one of the preceding items, wherein the membrane in step b) has a cut-off of 10-6000 Da, preferably 100-3000 Da or 3000-6000 Da.
10. The method according to any one of the preceding items, wherein the membrane in step c) has a cut-off of 10-6000 Da, preferably 100-3000 Da or 3000-6000 Da.
11. The method according to any one of the preceding items, wherein the membrane in step dn) has a cut-off of 10-6000 Da, preferably 100-3000 Da or 3000-6000 Da.
12. The method according to any one of the preceding items, wherein the membrane in step b), c) and dn) is a ceramic membrane and the pressure in this step is 2-60 bar, preferably 5-40 bar.
13. The method according to any one of the preceding items, wherein the membrane in step b), c) and dn) is a polymer membrane and the temperature in this step is 5-300° C., preferably 5-100° C., in particular 50-100° C.
14. The method according to any one of the preceding items, wherein the solvent is selected from alcohols, glycols, amines or mixtures thereof.
15. The method according to any one of the preceding items, wherein the solvent is selected from
   monoalcohols, in particular methanol, ethanol, propanol and mixtures thereof,
   diols, especially butanediol,
   glycols, in particular diethylene glycol, ethylene glycol, diethylene glycol, propylene glycol, and/or dipropylene glycol, or
   mixtures thereof.
16. The method according to any one of the preceding items, wherein the solvent has a molecular weight of 30-500 g/mol, preferably 30-250 g/mol.
17. The method according to any one of the preceding items, wherein the catalyst has a molecular weight of 30-500 g/mol, preferably 50-350 g/mol.
18. The method according to any one of the preceding items, wherein the catalyst is an alcoholate, preferably a methanolate, ethanolate or butanolate.
19. The method according to any one of the preceding items, wherein the catalyst is an alkali metal methanolate, preferably potassium methanolate or sodium methanolate.
20. The method according to any one of the preceding items wherein the catalyst is a metal catalyst such as titanium tetrabutanolate, tetrabutyl titanate, zinc-, magnesium or cobalt acetate or a mixture thereof.
21. The method according to any one of the preceding items, wherein the plastic degradation product is obtained by solvolysis of at least one polyurethane, polyester, polyether ester, polyamide, polycarbonate, polyisocyanurate, polylactide or a mixture thereof, preferably of at least one polyurethane.
22. The method according to any one of the preceding items, wherein the plastic degradation product is liquid at room temperature (20° C.) and preferably has a viscosity of in particular 10-100,000 mPa s, measured at 20° C.
23. The method according to any one of the preceding items, wherein the plastic degradation product is selected from polyamines, polyols, carbamates, polycarboxylic acids, polycarboxylic acid esters, hydroxycarboxylic acids, hydroxycarboxylic acid esters or mixtures thereof, preferably polyamines, polyols, carbamates, polycarboxylic acids and/or polycarboxylic acid esters.
24. The method according to any one of the preceding items, wherein the plastic degradation product comprises at least one polyol and at least one polyamine.
25. The method according to any one of the preceding items, wherein the plastic degradation product has a weight-average molecular weight of 30-20,000 g/mol, preferably 50-10,000 g/mol, in particular 100-5,000 g/mol.
26. The method according to any one of the preceding items, further comprising a distillation of the filtration residue A, C and/or En obtained in step b), c) and/or dn).
27. The method according to any one of the preceding items, further comprising a distillation of the filtrate B, D and/or Fn obtained in step b), c) and/or dn).
28. The method according to any one of the preceding items, wherein the plastic solvolysis mixture is subjected to solid/liquid filtration before step a).
29. The method according to any one of the preceding items, wherein the weight ratio of plastic degradation product: catalyst in the filtration residue A obtained in step b) is higher than in the plastic solvolysis mixture provided in step a).
30. The method according to any one of the preceding items, wherein a relative proportion of catalyst in the filtrate B with respect to the content of catalyst in the plastic solvolysis mixture provided in step a) (corresponds to 100%) is 80% or more, preferably 85% or more.
31. A plastic degradation product obtainable by a method according to any one of items 1-30, the plastic degradation product preferably being selected from polyamines, polyols, carbamates, polycarboxylic acids, polycarboxylic acid esters, hydroxycarboxylic acids, hydroxycarboxylic acid esters or mixtures thereof, in particular polyamines, polyols, carbamates, polycarboxylic acids and/or polycarboxylic acid esters.
32. The plastic degradation product according to item 31, wherein the plastic degradation product is liquid at room temperature (20° C.) and preferably has a viscosity of 10-100,000 mPa s, measured at 20° C.
33. The plastic degradation product according to item 31 or 32, wherein the plastic degradation product comprises at least one polyol, at least one polyamine or a mixture thereof.
34. A use of the plastics degradation product according to any one of items 31-33 for the production of plastics, in particular polyurethanes.
35. A use of the filtrate obtained in step b) according to any one of items 1-30 for the solvolysis of plastics.

1. A method for separating a plastic solvolysis mixture comprising the following steps:
a) providing a liquid plastic solvolysis mixture comprising plastic degradation product, solvent and catalyst,
b) carrying out a membrane filtration of the plastic solvolysis mixture provided in step a) at a temperature of 5-300° C., preferably 50-200° C. and a pressure of 2-150 bar, preferably 5-100 bar in order to obtain a filtration residue A and a filtrate B,
wherein the weight ratio catalyst:plastic degradation product in the filtrate B obtained in step b) is higher than in the plastic solvolysis mixture provided in step a).

2. The method according to claim 1, further comprising the step of
c) carrying out a membrane filtration of the filtration residue A obtained in step b) at a temperature of 5-300° C., preferably 50-200° C. and a pressure of 2-150 bar, preferably 5-100 bar in order to obtain a filtration residue C and a filtrate D
and optionally at least one additional membrane filtration step
dn) carrying out a membrane filtration of the filtration residue or filtrate obtained in the previous step at a temperature of 5-300° C., preferably 50-200° C. and a pressure of 2-150 bar, preferably 5-100 bar in order to obtain a filtration residue En and a filtrate Fn.

3. The method according to claim 1, wherein the plastic solvolysis mixture is in the form of a solution.

4. The method according to claim 1, wherein the membrane in step b), c) and/or dn) is a ceramic membrane or a polymer membrane.

5. The method according to claim 1, wherein the membrane in step b), c) and/or dn) has a cut-off of 10-6000 Da, preferably 100-3000 Da or 3000-6000 Da.

6. The method according to claim 1, wherein the membrane filtration in step b), c) and/or dn) is a diafiltration.

7. The method according to claim 1, wherein the solvent is selected from alcohols, glycols, amines or mixtures thereof, preferably monoalcohols, in particular methanol, ethanol, propanol, or mixtures thereof, diols, in particular butanediol, glycols, in particular diethylene glycol, ethylene glycol, diethylene glycol, propylene glycol, and/or dipropylene glycol, or mixtures thereof.

8. The method according to claim 1, wherein the catalyst is an alcoholate, preferably a methanolate, ethanolate or butanolate, in particular potassium methanolate or sodium methanolate, or a metal catalyst such as titanium tetrabutanolate, tetrabutyl titanate, zinc-, magnesium or cobalt acetate or a mixture thereof.

9. The method according to claim 1, wherein the solvent has a molecular weight of 30-500 g/mol, preferably 30-250 g/mol and/or wherein the catalyst has a molecular weight of 30-500 g/mol, preferably 50-350 g/mol.

10. The method according to claim 1, wherein the plastic degradation product is obtained by solvolysis of at least one polyurethane, polyester, polyether ester, polyamide, polycarbonate, polyisocyanurate, polylactide or a mixture thereof, preferably of at least one polyurethane.

11. The method according to claim 1, wherein the plastic degradation product is selected from polyamines, polyols, carbamates, polycarboxylic acids, polycarboxylic acid esters, hydroxycarboxylic acids, hydroxycarboxylic acid esters or mixtures thereof, preferably polyamines, polyols, carbamates, polycarboxylic acids and/or polycarboxylic acid esters.

12. The method according to claim 1, wherein a relative proportion of catalyst in the filtrate B with respect to the content of catalyst in the plastic solvolysis mixture provided in step a) (corresponds to 100%) is 80% or more, preferably 85% or more.

13. A plastic degradation product obtainable by a method according to claim 1, wherein the plastic degradation product is selected in particular from polyamines, polyols, carbamates, polycarboxylic acids, polycarboxylic acid esters, hydroxycarboxylic acids, hydroxycarboxylic acid esters or mixtures thereof, preferably polyamines, polyols, carbamates, polycarboxylic acids and/or polycarboxylic acid esters.

14. A use of the plastics degradation product according to claim 13 for the production of plastics, in particular polyurethanes.

15. A use of the filtrate obtained in step b) according to claim 1 for the solvolysis of plastics.
